(19) United States
(12) Patent Application Publication
(10) Pub. No.: US 2016/0377485 A1
(43) Pub. Date: Dec. 29, 2016

(54) SUSPENDED TYPE NANOWIRE ARRAY AND MANUFACTURING METHOD THEREOF

(71) Applicant: Korea Advanced Institute of Science And Technology, Daejeon (KR)

(72) Inventors: Jun-Bo YOON, Daejeon (KR); Kwang-Wook CHOI, Daejeon (KR); Jae-Shin LEE, Daejeon (KR); Min-Ho SEO, Daejeon (KR); Chang-Keun KIM, Daejeon (KR); Jae-Young YOO, Daejeon (KR)

(73) Assignee: Korea Advanced Institute of Science And Technology, Daejeon (KR)

(21) Appl. No.: 15/045,769

(22) Filed: Feb. 17, 2016

(30) Foreign Application Priority Data
Jun. 23, 2015 (KR) 10-2015-0089155

(51) Int. Cl. G01K 1/12; G01K 7/16; G01N 27/04

(52) U.S. Cl. CPC G01K 1/12; G01N 27/045; G01K 7/16

(57) ABSTRACT

A suspended type nanowire array and a manufacturing method thereof may be provided. More particularly, an array including a suspended type nanowire having two kinds of nanowires stacked thereon and a manufacturing method thereof may be provided. The suspended type nanowire array includes: a substrate; a suspended type nanowire which is suspended above the substrate and comprises a first nanowire, an insulating member, and a second nanowire which are sequentially stacked; a first electrode portion which is electrically connected to the first nanowire; and a second electrode portion which is electrically connected to the second nanowire.

### BACKGROUND

Field

This disclosure relates to a suspended type nanowire array and a manufacturing method thereof, and more particularly to an array including a suspended type nanowire having two kinds of nanowires stacked thereon and a manufacturing method thereof.

Description of the Related Art

A nanowire has particular characteristics which cannot be discovered in a macroscopic world due to its very small size. By using these particular characteristics, hyperfine and high performance electronic devices can be manufactured.

Some of the hyperfine and high performance electronic devices require nanowires heated to a high temperature for their operations.

Korean Registered Patent Publication No. 10-1403406 (hereinafter, referred to as a conventional technology) discloses a method for manufacturing a gas sensor and a temperature sensor which are based on a suspended type carbon nanowire.

The conventional technology is related to a method in which a micro-sized wire made by a semiconductor process is thermally decomposed at a high temperature, so that a carbon electrode and a suspended type carbon nanowire are integrally formed. Through this conventional technology, it is possible to manufacture a gas sensor which detects a gas concentration by stacking a particular material (gas detection material) on the carbon nanowire or a temperature sensor which detects a temperature by measuring a resistance value of the carbon nanowire.

The conventional technology relates to a method for forming carbon nanowires instead of nanowires made of various materials. Since it is impossible to heat the carbon nanowire at a high temperature, the conventional technology cannot be applied to an electronic device which requires the nanowire heated to high temperature.

Also, when the nanowire is heated at a high temperature, the nanowire is transformed by the high temperature, so that the nanowire itself may be damaged. Therefore, there is a requirement for a technology for preventing the nanowire itself from being damaged.

### SUMMARY

One embodiment is a suspended type nanowire array comprising: a substrate; a suspended type nanowire which is suspended above the substrate and comprises a first nanowire, an insulating member, and a second nanowire which are sequentially stacked; a first electrode portion which is electrically connected to the first nanowire; and a second electrode portion which is electrically connected to the second nanowire.

A length of the insulating member is less than a length of the first nanowire, and a length of the second nanowire is the same as or is less than the length of the insulating member.

The first nanowire is a heat radiator.

A plurality of the suspended type nanowires are provided. Two adjacent suspended type nanowires among the plurality of suspended type nanowires are disposed apart from each other at a predetermined distance. A duty ratio between the two first nanowires of the two suspended type nanowires is greater than 2.5%.

Materials of the first nanowire and the second nanowire are a metal or a metal oxide. The material of the first nanowire is different from the material of the second nanowire.

The insulating member is an insulating wire. The insulating wire covers an entire top surface and a portion of a side of the first nanowire. The second nanowire is disposed on a top surface of the insulating wire.

The insulating member is an insulating thin film.

A plurality of the suspended type nanowires are provided. The suspended type nanowire array further includes a first suspended type electrode which is disposed on the first nanowires of the plurality of suspended type nanowires; and a second suspended type electrode which is disposed on the second nanowires of the plurality of suspended type nanowires.

One end of each of the first nanowires is connected to the first electrode portion. The second electrode portion comprises a first electrode and a second electrode which are electrically connected through the second nanowires and the second suspended type electrode.

The first electrode portion comprises a first electrode connected to one end of the first nanowire and a second electrode connected to the other end of the first nanowire. The second electrode portion comprises a first electrode and a second electrode which are electrically connected through the second nanowire.

Each of the first electrode of the second electrode portion and the second electrode of the second electrode portion includes an extension electrode which is disposed on the second nanowire and is suspended above the substrate.

The substrate comprises protrusions on which the first electrode of the first electrode portion, the second electrode of the first electrode portion, the first electrode of the second electrode portion, and the second electrode of the second electrode portion are disposed respectively.

Another embodiment is a method for manufacturing a suspended type nanowire array. The method includes: forming a nanowire such that a first nanowire is formed on a predetermined number of protrusions of a nanograting substrate by using a photolithographic technique or a shadow mask technique, and an insulating member and a second nanowire are sequentially deposited on the first nanowire by using the photolithographic technique or the shadow mask technique; forming an electrode such that a first electrode portion which is electrically connected to the first nanowires and a second electrode portion which is electrically connected to the second nanowires are formed by using a patterning technique or the shadow mask technique; and etching the nanograting substrate by a predetermined thickness from a top surface to a bottom surface thereof.

In the forming an electrode, a first docking electrode is formed on the first nanowires, a second docking electrode is formed on the second nanowires, one end of each of the first nanowires is connected to the first electrode portion, and an extension electrode extending from the second electrode portion is formed on the second nanowires.

In the forming an electrode, one end of each of the first nanowires is connected to a first electrode of the first electrode portion, and the other end of each of the first nanowires is connected to a second electrode of the first electrode portion, and an extension electrode extending from the second electrode portion is formed on the second nanowires.

### BRIEF DESCRIPTION OF THE DRAWINGS

FIG. 1 is a perspective view of a suspended type nanowire array according to a first embodiment of the present invention;

FIG. 2 is a side view of the suspended type nanowire array shown in FIG. 1;

FIG. 3 is a cross sectional view taken along line A-A′ shown in FIG. 1

FIG. 4 is a cross sectional view of a suspended type nanowire 100′, i.e., a modified example of a suspended type nanowire 100 shown in FIG. 3;

FIG. 5 is a view for describing a temperature difference due to a predetermined interval between a plurality of the suspended type nanowires 100 shown in FIG. 1;

FIG. 6 shows a relative temperature distribution according to a duty ratio between the plurality of the suspended type nanowires 100 shown in FIG. 1 and a relative temperature distribution according to a duty ratio between typical substrate attachment type nanowires;

FIGS. 7, 8, 9, 10, and 11 are views for describing a method for manufacturing the suspended type nanowire array according to the first embodiment of the present invention shown in FIG. 1;

FIG. 12 is a perspective view of a suspended type nanowire array according to a second embodiment of the present invention; and

FIG. 13 is an actual electron microscope photograph showing the suspended type nanowire 100 shown in FIG. 1 or 12.

### DETAILED DESCRIPTION

The embodiment of the present invention can be variously transformed, and the scope of the present invention is not limited to the following embodiment. The shapes and sizes of the components in the drawings may be exaggerated for clarity of the description. It is noted that the same reference numerals are used to denote the same elements throughout the drawings. In the following description of the present invention, the detailed description of known functions and configurations incorporated herein is omitted when it may make the subject matter of the present invention unclear.

Hereinafter, a suspended type nanowire array according to an embodiment of the present invention and a manufacturing method thereof will be described with reference to the accompanying drawings.

### First Embodiment

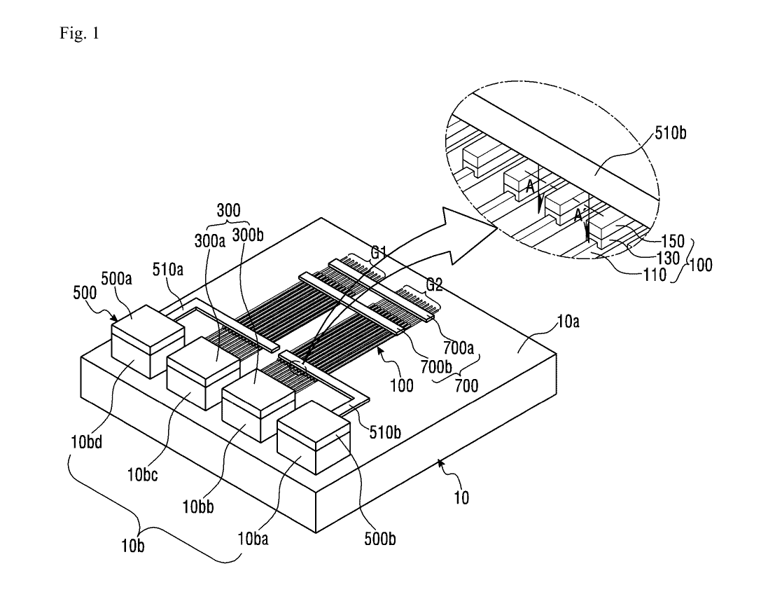

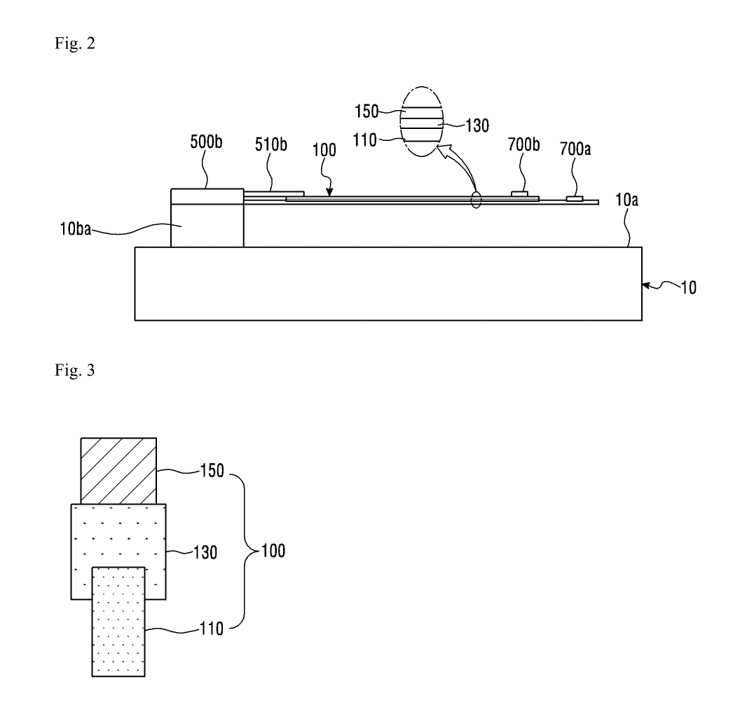

FIG. 1 is a perspective view of a suspended type nanowire array according to a first embodiment of the present invention. FIG. 2 is a side view of the suspended type nanowire array shown in FIG. 1. FIG. 3 is a cross sectional view taken along line A-A′ shown in FIG. 1.

Referring to FIGS. 1 to 3, the suspended type nanowire array (or suspension type nanowire array) according to the first embodiment of the present invention may include a substrate 10, a suspended type nanowire 100, a first electrode portion 300, a second electrode portion 500, and suspended type electrode portion 700.

The suspended type nanowire 100, the first electrode portion 300, the second electrode portion 500, and the suspended type electrode portion 700 are disposed on the substrate 10.

The substrate 10 includes a top surface 10a and a protrusion 10b.

The suspended type nanowire 100 and the suspended type electrode portion 700 may be disposed on the top surface 10a of the substrate 10. Specifically, the suspended type nanowire 100 and the suspended type electrode portion 700 may be disposed apart from the top surface 10a of the substrate 10 at a predetermined distance.

The protrusion 10b may be disposed on the top surface 10a. Here, the protrusion 10b may be made of a material the same as that of the substrate 10 and may extend from the top surface 10a.

A plurality of the protrusions 10b may be disposed on the top surface 10a. The plurality of protrusions 10ba, 10bb, 10bc, and 10bd may be arranged in a line. The plurality of protrusions 10ba, 10bb, 10bc, and 10bd arranged in a line may be disposed apart from each other at a predetermined interval.

The first electrode portion 300 and the second electrode portion 500 may be disposed on the plurality of protrusions 10ba, 10bb, 10bc, and 10bd, respectively. Specifically, as shown in the drawing, when four protrusions 10ba, 10bb, 10bc, and 10bd are provided, a second electrode 500b of the second electrode portion 500 may be disposed on a first protrusion 10ba, a second electrode 300b of the first electrode portion 300 may be disposed on a second protrusion 10bb, a first electrode 300a of the first electrode portion 300 may be disposed on a third protrusion 10bc, and a first electrode 500a of the second electrode portion 500 may be disposed on a fourth protrusion 10bd.

While the plurality of protrusions 10b are shown in the drawing, one protrusion 10b may be provided. Also, the first electrode portion 300 and the second electrode portion 500 may be disposed on one protrusion 10b and are apart from each other.

The suspended type nanowire 100 is suspended above the substrate 10. The suspended type nanowire 100 is disposed apart from the top surface 10a of the substrate 10 at a predetermined distance. When the suspended type nanowire 100 is suspended above the substrate 10, heat which is transferred (lost) to the substrate 10 by conduction is minimized, so that it is possible to maximize the energy efficiency of the suspended type nanowire 100 and to reduce the possibility that the structure of the suspended type nanowire 100 is damaged by deformation of the substrate due to the high temperature of the suspended type nanowire 100.

The suspended type nanowire 100 includes a first nanowire 110, an insulating member 130, and a second nanowire 150.

One end of the first nanowire 110 is connected to the first electrode portion 300, and the other end of the first nanowire 110 is disposed apart from the substrate 10 at a predetermined interval. In this case, the first nanowire 110 is not cut in spite of expanding by the heat. That is, resistance to stress of the first nanowire 110 can be improved. If the one and the other ends of the first nanowire 110 are fixed, the first nanowire 110 may be cut by internal stress when the first nanowire 110 thermally expands. However, when the other end of the first nanowire 110 is not fixed to the first electrode portion 300 and is disposed apart from the substrate 10 at a predetermined interval, the first nanowire 110 is able to freely expand or contract, so that the first nanowire 110 is not cut by the internal stress.

The suspended type electrode portion 700 is disposed on the first nanowire 110. A first suspended type electrode 700a of the suspended type electrode portion 700 is disposed on the other end of the first nanowire 110.

The first nanowire 110 may be a metal or a metal oxide. When the first nanowire 110 is a metal, a higher temperature can be obtained by a low power consumption. This is caused by thermal isolation of the first nanowire 110 made of a metallic material. The thermal isolation means that the electron mobility of the metal-made first nanowire 110 is reduced by the scattering due to a very narrow moving path, so that thermal conductivity is reduced.

The second nanowire 150 is disposed on the first nanowire 110. One end of the second nanowire 150 is connected to the second electrode portion 500. As mentioned, when the one end of the second nanowire 150 is connected to the second electrode portion 500 and the other end of the second nanowire 150 is not connected to the second electrode portion 500, the second nanowire 150 is not cut in spite of expanding by the heat. That is, for the same reason as that of the above-described first nanowire 110, resistance to stress of the second nanowire 150 can be improved.

The length of the second nanowire 150 may be less than that of the first nanowire 110. The width of the second nanowire 150 may be greater than that of the first nanowire 110.

Extension electrodes 510a and 510b of the second electrode portion 500 may be disposed on the second nanowire 150. The extension electrodes 510a and 510b of the second electrode portion 500 may be disposed on one end of the second nanowire 150.

The suspended type electrode portion 700 may be disposed on the second nanowire 150. A second suspended type electrode 700b of the suspended type electrode portion 700 may be disposed on the other end of the second nanowire 150.

The second nanowire 150 may be a metal or a metal oxide. When the second nanowire 150 is a metal, a higher temperature can be obtained by a low power consumption. This is caused by thermal isolation of the second nanowire 150 made of a metallic material. The thermal isolation means that the electron mobility of the metal-made second nanowire 150 is reduced by the scattering due to a very narrow moving path, so that thermal conductivity is reduced.

The material of the second nanowire 150 may be different from that of the first nanowire 110. For example, the material of the first nanowire 110 may be a metallic material such as Pt, and the material of the second nanowire 150 may be a metal oxide such as a tin oxide (SnO₂). Here, when the material of the first nanowire 110 is Pt and the material of the second nanowire 150 is tin oxide (SnO₂), the suspended type nanowire array according to the first embodiment of the present invention can be used as a gas sensor.

The insulating member 130 is disposed between the first nanowire 110 and the second nanowire 150.

The insulating member 130 is disposed on the first nanowire 110, and the second nanowire 150 is disposed on the insulating member 130. While the first nanowire 110 and the second nanowire 150 are electrically insulated from each other by the insulating member 130, the insulating member 130 is able to thermally conduct heat radiated from the first nanowire 110 to the second nanowire 150 or conduct heat radiated from the second nanowire 150 to the first nanowire 110.

The insulating member 130 may have, as shown in FIG. 3, a shape of a wire. That is, the insulating member 130 may be an insulating wire. The length of the insulating member 130 may be less than that of the first nanowire 110 and may be the same as that of the second nanowire 150. Also, the length of the insulating member 130 may be less than that of the first nanowire 110 and may be greater than that of the second nanowire 150.

The insulating member 130 may cover an upper portion of the first nanowire 110. In other words, the insulating wire 130 may be disposed on the entire top surface and a portion of the side of the first nanowire 110. Also, the second nanowire 150 may be disposed on the top surface of the insulating wire 130.

The first nanowire 110 may be a nano heat radiator which radiates heat. When the first nanowire 110 radiates heat, the heat radiated from the first nanowire 110 is conducted to the second nanowire 150 through the insulating wire 130. Therefore, the second nanowire 150 may be heated to a high temperature by the first nanowire 110. Meanwhile, contrary to this, the second nanowire 150 may be a nano heat radiator which radiates heat, and the first nanowire 110 may be heated to a high temperature by the second nanowire 150.

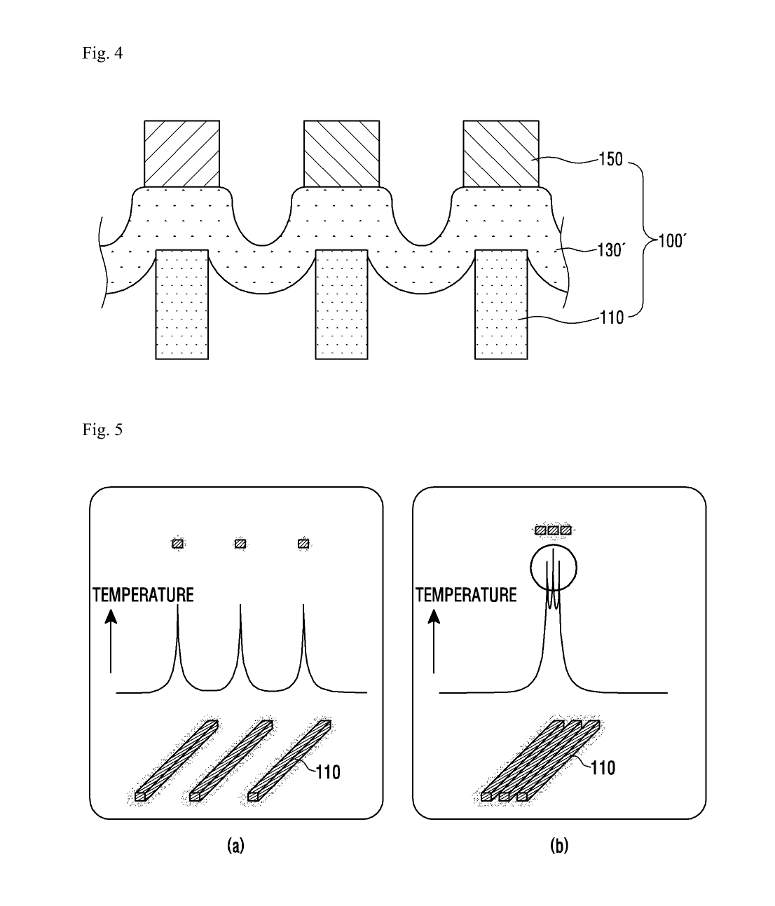

Meanwhile, the insulating member 130 may have a thin film shape. This will be described in detail with reference to FIG. 4.

FIG. 4 is a cross sectional view of a suspended type nanowire 100′, i.e., a modified example of the suspended type nanowire 100 shown in FIG. 3.

Referring to FIG. 4, the suspended type nanowire 100′ includes the first nanowire 110, an insulating member 130′, and the second nanowire 150. The first nanowire 110 and the second nanowire 150 are the same as the first nanowire 110 and the second nanowire 150 shown in FIG. 3.

The insulating member 130′ has a structure different from that of the insulating member 130 shown in FIG. 3.

The insulating member 130′ may be an insulating thin film. The insulating thin film 130′ may be disposed between a plurality of the first nanowires 110 and a plurality of the second nanowires 150.

The insulating thin film 130′ may have a predetermined thickness and may include a first convex portion which is upwardly convex and a second convex portion which is downwardly convex. The first convex portion is disposed on the first nanowire 110, and the second convex portion may be disposed between two adjacent first nanowires 110. The insulating thin film 130′ provides electrical insulation not only between the first nanowire 110 and the second nanowire 150 but also between the first nanowire 110 and another second nanowire 150 located diagonally with respect to the first nanowire 110. Therefore, the suspended type nanowire array can be more stably driven.

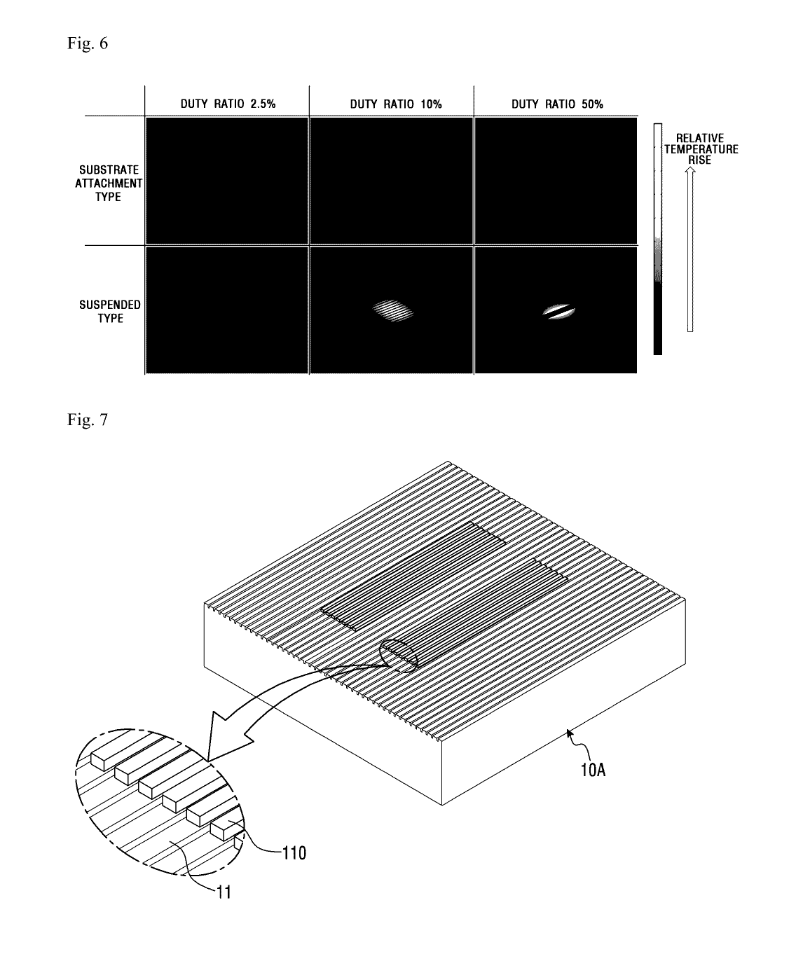

Referring back to FIGS. 1 to 3, a plurality of the above-described suspended type nanowires 100 may be provided. The plurality of suspended type nanowires 100 may be disposed apart from each other at a predetermined interval. Here, it means that the predetermined interval between the two adjacent nanowires 100 is less an interval in which a temperature of one suspended type nanowire is affected by the temperature of another suspended type nanowire. This will be described in more detail with reference to FIGS. 5 and 6.

FIG. 5 is a view for describing a temperature difference due to a predetermined interval between the plurality of suspended type nanowires 100 shown in FIG. 1.

A case where a temperature of one first nanowire 110 is not affected by the temperature of another adjacent first nanowire is shown in (a) of FIG. 5. A case where a temperature of one first nanowire 110 is affected by the temperature of another adjacent first nanowire is shown in (b) of FIG. 5. In (a) and (b) of FIG. 5, it is assumed that the first nanowires 110 are all heated to the same temperature.

Referring to (a) and (b) of FIG. 5, when a predetermined interval between the two adjacent first nanowires 110 is, as shown in (b) of FIG. 5, less than an interval in which a temperature of one first nanowire is affected by the temperature of another first nanowire, a temperature higher than the temperature of (a) of FIG. 5 can be obtained. This is based on a phenomenon in which the heat radiated from each of the first nanowires 110 are constructed and overlapped.

FIG. 6 shows a relative temperature distribution according to a duty ratio between the plurality of suspended type nanowires 100 shown in FIG. 1 and a relative temperature distribution according to a duty ratio between typical substrate attachment type nanowires.

In FIG. 6, the ten first nanowires 110 shown in FIG. 1 are used and the ten first nanowires 110 are assumed to consume the same amount of power. The material of the first nanowire 110 is palladium, and the width of the first nanowire 110 is 50 nm.

For reference, FIG. 6 shows a temperature distribution of the cross-section formed by cutting the first nanowire 110 shown in FIG. 1. Only the ambient temperatures of the first nanowire 110 are distinguished by colors.

When a sum of the width of the first nanowire 110 and the interval between the two adjacent first nanowires 110 is assumed to be 100%, the duty ratio shown in FIG. 6 means a ratio of the width of the first nanowire 110 to the sum. The duty ratio of 50% means that the width of the first nanowire 110 is the same as the interval between the two adjacent first nanowires 110. The duty ratio of 10% means that when the width of the first nanowire 110 is 50 nm, the interval between the two adjacent first nanowires 110 is 450 mm.

Referring to FIG. 6, it can be found that the relative temperature distribution of the suspended type nanowires is higher than the relative temperature distribution of the substrate attachment type nanowires. It can be also found that when the duty ratio between the first nanowires is greater than 2.5%, a temperature of one first nanowire is affected by the temperature of another adjacent first nanowire.

Referring back to FIGS. 1 to 3, the plurality of suspended type nanowires 100 may be divided into a first group G1 and a second group G2. Each of the first and the second groups G1 and G2 may include at least one suspended type nanowire 100.

One end of the first nanowire 110 of each of the suspended type nanowires 100 included in the first group G1 is connected to the first electrode 300a of the first electrode portion 300. The other end of the first nanowire 110 is suspended above the substrate 10.

One end of the first nanowire 110 of each of the suspended type nanowires 100 included in the second group G2 is connected to the second electrode 300b of the first electrode portion 300. The other end of the first nanowire 110 is suspended above the substrate 10.

The first suspended type electrode 700a disposed on the other end of the first nanowire 110 of each of all of the suspended type nanowires 100. The first nanowires 110 of the suspended type nanowires 100 included in the first group G1 may be electrically connected to the first nanowires 110 of the suspended type nanowires 100 included in the second group G2 by the first suspended type electrode 700a. A current which is input through the first electrode 300a of the first electrode portion 300 may sequentially flow into the second electrode 300b of the first electrode portion 300 through the first nanowires 110 of the suspended type nanowires 100 included in the first group G1, the first suspended type electrode 700a, and the first nanowires 110 of the suspended type nanowires 100 included in the second group G2.

Meanwhile, one end of the second nanowire 150 of each of the suspended type nanowires 100 included in the first group G1 is electrically connected to the first electrode 500a of the second electrode portion 500. The other end of the second nanowire 150 is suspended above the substrate 10.

Here, the one end of the second nanowire 150 may be electrically connected to the first electrode 500a of the second electrode portion 500 through the extension electrode 510a of the first electrode 500a of the second electrode portion 500. One end of the extension electrode 510a is connected to the first electrode 500a, and the other end of the extension electrode 510a is disposed on one end of the second nanowire 150 of each of the suspended type nanowires 100 included in the first group G1.

One end of the second nanowire 150 of each of the suspended type nanowires 100 included in the second group G2 is electrically connected to the second electrode 500b of the second electrode portion 500. The other end of the second nanowire 150 is suspended above the substrate 10.

Here, the one end of the second nanowire 150 may be electrically connected to the second electrode 500b of the second electrode portion 500 through the extension electrode 510b of the second electrode 500b of the second electrode portion 500. One end of the extension electrode 510b is connected to the second electrode 500b, and the other end of the extension electrode 510b is disposed on one end of the second nanowire 150 of each of the suspended type nanowires 100 included in the second group G2.

The second suspended type electrode 700b disposed on the other end of the second nanowire 150 of each of all of the suspended type nanowires 100. The second nanowire 150 of the suspended type nanowires 100 included in the first group G1 may be electrically connected to the second nanowire 150 of the suspended type nanowires 100 included in the second group G2 by the second suspended type electrode 700b. A current which is input through the first electrode 500a of the second electrode portion 500 may sequentially flow into the second electrode 500b of the second electrode portion 500 through the second nanowires 150 of the suspended type nanowires 100 included in the first group G1, the second suspended type electrode 700b, and the second nanowires 150 of the suspended type nanowires 100 included in the second group G2.

As such, in the suspended type nanowire 100, since the insulating member 130 is located between the first nanowire 110 and the second nanowire 150, the first nanowire 110 and the second nanowire 150 can have mutually independent electrical paths.

The first electrode portion 300 may be disposed on the protrusion 10b of the substrate 10 and may include the first electrode 300a and the second electrode 300b.

The first electrode 300a may be disposed on the third protrusion 10bc among the first to the fourth protrusions 10ba, 10bb, 10bc, and 10bd arranged in a line. The second electrode 300b may be disposed on the second protrusion 10bb.

The first electrode 300a may be a positive (+) electrode and the second electrode 300b may be a negative (−) electrode. Contrary to this, the first electrode 300a may be a negative (−) electrode and the second electrode 300b may be a positive (+) electrode.

The first electrode 300a is connected to one end of the first nanowire 110 of the suspended type nanowire 100 included in the first group G1. Here, one side of the first electrode 300a may be connected to one end of the first nanowire 110.

The second electrode 300b is connected to one end of the first nanowire 110 of the suspended type nanowire 100 included in the second group G2. Here, one side of the second electrode 300b may be connected to one end of the first nanowire 110.

The second electrode portion 500 may be disposed on the protrusion 10b of the substrate 10 and may include the first electrode 500a and the second electrode 500b.

The first electrode 500a may be disposed on the fourth protrusion 10bd among the first to the fourth protrusions 10ba, 10bb, 10bc, and 10bd arranged in a line. The second electrode 500b may be disposed on the first protrusion 10ba.

The first electrode 500a may be a positive (+) electrode and the second electrode 500b may be a negative (−) electrode. Contrary to this, the first electrode 500a may be a negative (−) electrode and the second electrode 500b may be a positive (+) electrode.

The first electrode 500a is electrically connected to one end of the second nanowire 150 of the suspended type nanowire 100 included in the first group G1. Here, first electrode 500a may include the extension electrode 510a which is connected to one end of the second nanowire 150. One end of the extension electrode 510a may be connected to the first electrode 500a, and the other end of the extension electrode 510a may be connected to one end of the second nanowire 150 by being disposed on one end of the second nanowire 150. The extension electrode 510a may be made of a material the same as that of the first electrode 500a, together with the first electrode 500a. Since the extension electrode 510a is suspended above the substrate 10, the extension electrode 510a can be designated as a suspended type electrode of the first electrode 500a.

The second electrode 500b is electrically connected to one end of the second nanowire 150 of the suspended type nanowire 100 included in the second group G2. Here, second electrode 500b may include the extension electrode 510b which is connected to one end of the second nanowire 150. One end of the extension electrode 510b may be connected to the second electrode 500b, and the other end of the extension electrode 510b may be connected to one end of the second nanowire 150 by being disposed on one end of the second nanowire 150. The extension electrode 510b may be made of a material the same as that of the second electrode 500b, together with the second electrode 500b. Since the extension electrode 510b is suspended above the substrate 10, the extension electrode 510b can be designated as a suspended type electrode of the second electrode 500b.

The suspended type electrode portion 700 may be disposed on the suspended type nanowires 100 and may include the first suspended type electrode 700a and the second suspended type electrode 700b.

Since the suspended type electrode portion 700 is disposed on the suspended type nanowires 100, the suspended type electrode portion 700 is suspended above the substrate 10.

Each of the first suspended type electrode 700a and the second suspended type electrode 700b may have a flat plate shape which extends in a direction perpendicular to a longitudinal direction of the suspended type nanowire 100.

The first suspended type electrode 700a is connected to the other end of the first nanowire 110 by being disposed on the other end of the first nanowire 110 of each of all of the suspended type nanowires 100.

The second suspended type electrode 700b is connected to the other end of the second nanowire 150 by being disposed on the other end of the second nanowire 150 of each of all of the suspended type nanowires 100.

FIGS. 7 to 11 are views for describing a method for manufacturing the suspended type nanowire array according to the first embodiment of the present invention shown in FIG. 1.

Referring to FIG. 7, the first nanowire 110 is formed on a nanograting substrate 10A by using a photolithographic technique.

The photolithographic technique corresponds to a general photolithographic technique which is used in a semiconductor process.

The first nanowire 110 is formed on a predetermined number of protrusions 11 of the nanograting substrate 10A by using the photolithographic technique. By using a shadowing effect of the protrusion 11, the wire-shaped first nanowire 110 can be easily formed by simple deposition or oblique deposition.

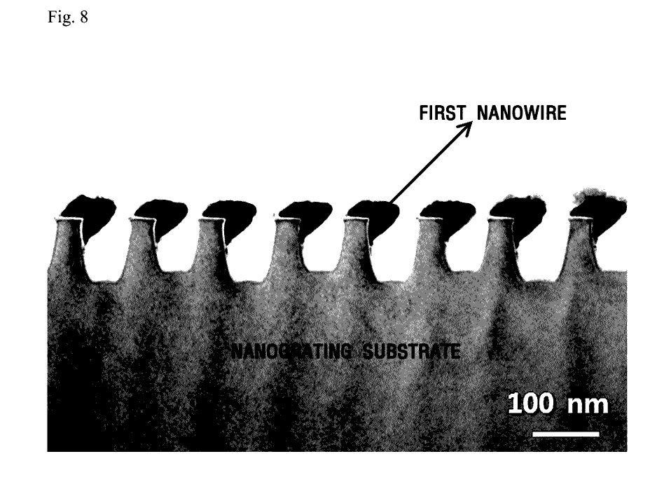

FIG. 8 is a cross-sectional TEM image showing the first nanowire 110 formed on the nanograting substrate 10A by oblique deposition. Referring to FIG. 8, the first nanowire is disposed on the protrusion of the nanograting substrate. The first nanowire may be disposed on the top surface of the protrusion and on the upper portion of the side of the protrusion by oblique deposition.

All of future patterning processes can be more simplified by using a shadow mask instead of photolithography.

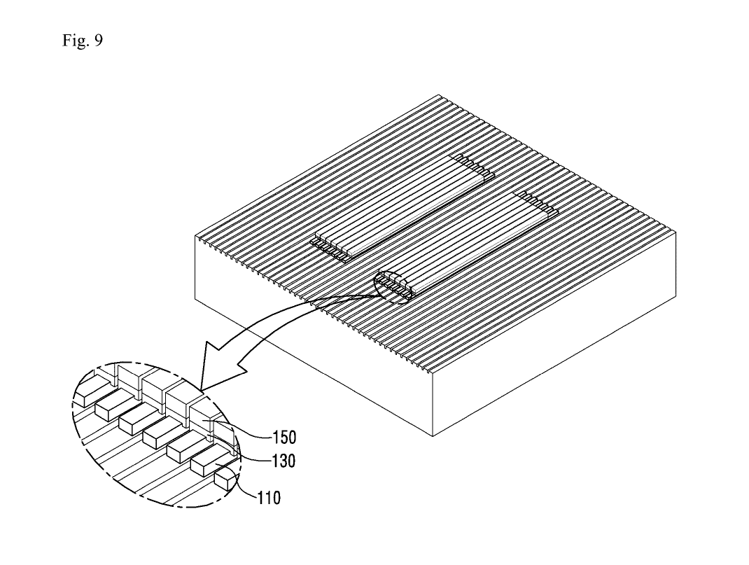

Next, referring to FIG. 9, the insulating member 130 and the second nanowire 150 are sequentially deposited on the first nanowire 110 by using the photolithographic technique. Specifically, the insulating member 130 is formed on the entire top surface and a portion of the side of the first nanowire 110 by using the photolithographic technique, and then the second nanowire 150 is formed on the insulating member 130. Also, in the formation of the second nanowire 150, the second nanowire 150 is not intended to be directly connected to the first nanowire 110.

The method for forming the insulating member 130 and the second nanowire 150 uses simple deposition or oblique deposition. Therefore, it is possible to manufacture nanowires made of various materials if necessary.

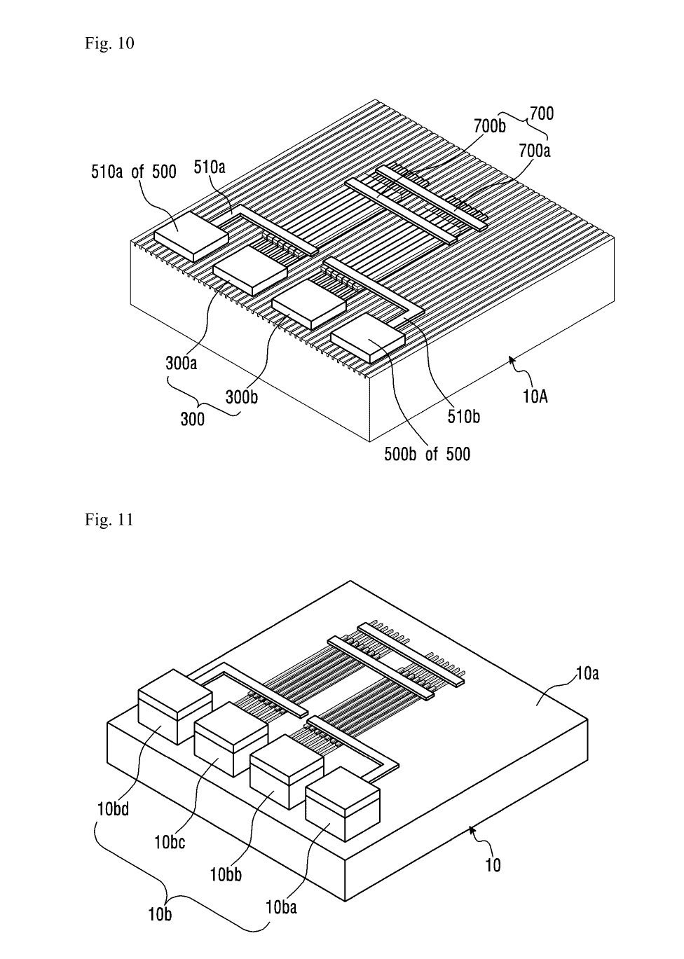

Next, referring to FIG. 10, the first electrode portion 300 which is electrically connected to the first nanowire 110, the second electrode portion 500 which is electrically connected to the second nanowire 150, and the docking electrode portion 700 are formed by using a patterning technique or a shadow mask technique.

Here, it is desirable that the docking electrode portion 700 to be suspended for a stress resistant structure should be manufactured to have a sufficiently small width, so that the material located at the lower portion of the docking electrode portion 700 is intended to be removed by isotropic etching.

Since the first electrode portion 300, the second electrode portion 500, and the docking electrode portion 700 are formed by using a patterning technique or a shadow mask technique, there is an advantage in that the suspended type nanowire array arranged simultaneously with the manufacture thereof can be immediately used in the manufacture of a device without a separate additional process. Meanwhile, the conventional substrate attachment type nanowire is manufactured by an existing common chemical synthesis, it is complicated to transfer the substrate attachment type nanowire to a substrate which is used to manufacture the device. However, the manufacturing method according to the embodiment of the present invention does not include the above-mentioned complicate process.

Lastly, the nanograting substrate 10A shown in FIG. 10 is etched by a predetermined thickness from the top surface to the bottom surface, so that the substrate 10 including the top surface 10a and the protrusion 10b is, as shown in FIG. 11, formed.

The etching method may include a chemical etching method. Since the first nanowire 110 has a sufficiently small width, a slight isotropic etching which inevitably exists is enough to completely remove the material located at the lower portion of the first nanowire 110.

The first electrode portion 300, the second electrode portion 500, and the docking electrode portion 700 function as a mask during the etching process. Therefore, a separate patterning process is not required. The docking electrode portion 700 is suspended by etching the nanograting substrate 10A.

Through the manufacturing method shown in FIGS. 7 to 11, it is possible to manufacture the suspended type nanowire array with a highly advanced structure only by using a semiconductor process technology. Therefore, the manufacturing method has a high productivity, so that the suspended type nanowire array can be mass-produced and manufactured by a batch process.

Also, due to the characteristics of the nanograting-based nanowire manufacturing method using simple deposition, nanowires made of various materials can be used in a variety of electronic devices requiring operations at high temperature.

Also, hundreds and thousands of the completely arranged suspended type nanowires are used, so that measured detection signals are leveled and high reliability is obtained.

Also, the length or area of the suspended type nanowire array is precisely controlled in a unit of several micrometers.

### Second Embodiment

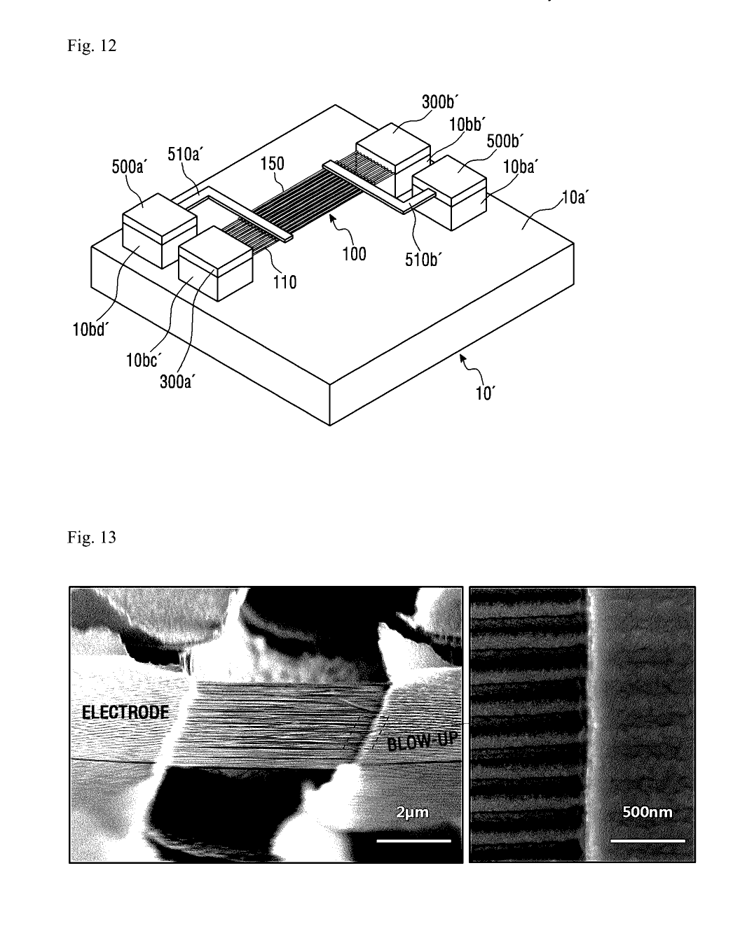

FIG. 12 is a perspective view of a suspended type nanowire array according to a second embodiment of the present invention.

Referring to FIG. 12, the suspended type nanowire array according to the second embodiment of the present invention may include a substrate 10′, the suspended type nanowire 100, a first electrode portion 300′, a second electrode portion 500′.

The suspended type nanowire array according to the second embodiment is different from the suspended type nanowire array according to the first embodiment shown in FIG. 1 in that suspended type nanowire array according to the second embodiment does not include the suspended type electrode portion 700 shown in FIG. 1. Additionally, there are also differences in the structure of the substrate 10′, the position of the first electrode portion 300′, and the position of the second electrode portion 500′.

The substrate 10′ includes a top surface 10a′ and the first to the fourth protrusions 10ba′, 10bb′, 10bc′, and 10bd′ disposed on the top surface 10a′.

The first protrusion 10ba′ and the second protrusion 10bb′ are disposed on one side of the top surface 10a′ in a line. The third protrusion 10bc′ and the fourth protrusion 10bd′ are disposed on the other side of the top surface 10a′ in a line. The second protrusion 10bb′ and the third protrusion 10bc′ are disposed opposite to each other. Here, while FIG. 12 shows that the first protrusion 10ba′ and the fourth protrusion 10bd′ are not disposed opposite to each other, the first protrusion 10ba′ and the fourth protrusion 10bd′ are not limited to this. The first protrusion 10ba′ and the fourth protrusion 10bd′ may be also disposed opposite to each other.

The first electrode portion 300′ includes a first electrode 300a′ and a second electrode 300b′.

The first electrode 300a′ is disposed on the third protrusion 10bc′, and the second electrode 300b′ is disposed on the second protrusion 10bb′.

The first electrode 300a′ is connected to one end of the first nanowire 110 of the suspended type nanowire 100, and the second electrode 300b′ is connected to the other end of the first nanowire 110 of the suspended type nanowire 100. The suspended type nanowire 100 can be suspended above the substrate 10′ by the first electrode 300a′ and the second electrode 300b′.

The first electrode 300a′ may be a positive (+) electrode and the second electrode 300b′ may be a negative (−) electrode, and vice versa.

The second electrode portion 500′ includes a first electrode 500a′ and a second electrode 500b′.

The first electrode 500a′ is disposed on the fourth protrusion 10bd′, and the second electrode 500b′ is disposed on the first protrusion 10ba′.

The first electrode 500a′ is electrically connected to one end of the second nanowire 150 of the suspended type nanowire 100, and the second electrode 500b′ is electrically connected to the other end of the second nanowire 150 of the suspended type nanowire 100.

The first electrode 500a′ may include an extension electrode 510a′ which is electrically connected to one end of the second nanowire 150 of the suspended type nanowire 100. One end of the extension electrode 510a′ may be connected to the first electrode 500a′, and the other end of the extension electrode 510a′ may be connected to the second nanowire 150 by being disposed on one end of the second nanowire 150 of the suspended type nanowire 100.

The second electrode 500b′ may include an extension electrode 510b′ which is electrically connected to the other end of the second nanowire 150 of the suspended type nanowire 100. One end of the extension electrode 510b′ may be connected to the second electrode 500b′, and the other end of the extension electrode 510b′ may be connected to the second nanowire 150 by being disposed on the other end of the second nanowire 150 of the suspended type nanowire 100.

The first electrode 500a′ may be a positive (+) electrode and the second electrode 500b′ may be a negative (−) electrode, and vice versa.

The suspended type nanowire 100 of the suspended type nanowire array according to the second embodiment has the same structure as that of the suspended type nanowire 100 of the suspended type nanowire array according to the first embodiment shown in FIG. 1. However, the connection structure to the first electrode portion 300′ of the second embodiment is different from that of the first embodiment.

Specifically, one end of the suspended type nanowire 100 of the suspended type nanowire array according to the second embodiment is connected to the first electrode 300a′ of the first electrode portion 300′, and the other end of the suspended type nanowire 100 of the suspended type nanowire array according to the second embodiment is connected to the second electrode 300b′ of the first electrode portion 300′.

In the structure of the suspended type nanowire array according to the second embodiment, the same parts as the structure of the suspended type nanowire array according to the first embodiment can provide the same technical effect as that of the suspended type nanowire array according to the first embodiment.

FIG. 13 is an actual electron microscope photograph showing the suspended type nanowire 100 shown in FIG. 1 or 12.

While the embodiment of the present invention has been described with reference to the accompanying drawings, these are just examples and do not limit the present invention. Further, the present invention may be changed and modified in various ways, without departing from the essential features of the present invention, by those skilled in the art. For example, the components described in detail in the embodiments of the present invention may be modified.

1. A suspended type nanowire array comprising:
a substrate;
a suspended type nanowire which is suspended above the substrate and comprises a first nanowire, an insulating member, and a second nanowire which are sequentially stacked;
a first electrode portion which is electrically connected to the first nanowire; and
a second electrode portion which is electrically connected to the second nanowire.

2. The suspended type nanowire array of claim 1, wherein a length of the insulating member is less than a length of the first nanowire, and wherein a length of the second nanowire is the same as or is less than the length of the insulating member.

3. The suspended type nanowire array of claim 1, wherein the first nanowire is a heat radiator.

4. The suspended type nanowire array of claim 1, wherein a plurality of the suspended type nanowires are provided, wherein two adjacent suspended type nanowires among the plurality of suspended type nanowires are disposed apart from each other at a predetermined distance, and wherein a duty ratio between the two first nanowires of the two suspended type nanowires is greater than 2.5%.

5. The suspended type nanowire array of claim 1, wherein materials of the first nanowire and the second nanowire are a metal or a metal oxide, and wherein the material of the first nanowire is different from the material of the second nanowire.

6. The suspended type nanowire array of claim 1, wherein the insulating member is an insulating wire, wherein the insulating wire covers an entire top surface and a portion of a side of the first nanowire, and wherein the second nanowire is disposed on a top surface of the insulating wire.

7. The suspended type nanowire array of claim 1, wherein the insulating member is an insulating thin film.

8. The suspended type nanowire array of claim 1, wherein a plurality of the suspended type nanowires are provided, and further comprising:
a first suspended type electrode which is disposed on the first nanowires of the plurality of suspended type nanowires; and
a second suspended type electrode which is disposed on the second nanowires of the plurality of suspended type nanowires.

9. The suspended type nanowire array of claim 8, wherein one end of each of the first nanowires is connected to the first electrode portion, and wherein the second electrode portion comprises a first electrode and a second electrode which are electrically connected through the second nanowires and the second suspended type electrode.

10. The suspended type nanowire array of claim 1, wherein the first electrode portion comprises a first electrode connected to one end of the first nanowire and a second electrode connected to the other end of the first nanowire, and wherein the second electrode portion comprises a first electrode and a second electrode which are electrically connected through the second nanowire.

11. The suspended type nanowire array of claim 9, wherein each of the first electrode of the second electrode portion and the second electrode of the second electrode portion comprises an extension electrode which is disposed on the second nanowire and is suspended above the substrate.

12. The suspended type nanowire array of claim 9, wherein the substrate comprises protrusions on which the first electrode of the first electrode portion, the second electrode of the first electrode portion, the first electrode of the second electrode portion, and the second electrode of the second electrode portion are disposed respectively.

13. A method for manufacturing a suspended type nanowire array, the method comprising:
forming a nanowire such that a first nanowire is formed on a predetermined number of protrusions of a nanograting substrate by using a photolithographic technique or a shadow mask technique, and an insulating member and a second nanowire are sequentially deposited on the first nanowire by using the photolithographic technique or the shadow mask technique;
forming an electrode such that a first electrode portion which is electrically connected to the first nanowires and a second electrode portion which is electrically connected to the second nanowires are formed by using a patterning technique or the shadow mask technique; and
etching the nanograting substrate by a predetermined thickness from a top surface to a bottom surface thereof.

14. The method of claim 13, wherein, in the forming an electrode, a first docking electrode is formed on the first nanowires, a second docking electrode is formed on the second nanowires, one end of each of the first nanowires is connected to the first electrode portion, and an extension electrode extending from the second electrode portion is formed on the second nanowires.

15. The method of claim 13, wherein, in the forming an electrode, one end of each of the first nanowires is connected to a first electrode of the first electrode portion, and the other end of each of the first nanowires is connected to a second electrode of the first electrode portion, and an extension electrode extending from the second electrode portion is formed on the second nanowires.
